(19) United States
(12) Patent Application Publication
(10) Pub. No.: US 2007/0298293 A1
(43) Pub. Date: Dec. 27, 2007

(54) Electrode for fuel cell and, membrane-electrode assembly and fuel cell system including the same

(76) Inventor: In-Hyuk Son, Suwon-si (KR)

Correspondence Address: Robert E. Bushnell, Suite 300, 1522 K Street, N.W., Washington, DC, 20005-1202, US

(21) Appl. No.: 11/730,337

(22) Filed: Mar. 30, 2007

(30) Foreign Application Priority Data
Mar. 31, 2006 (KR) 10-2006-0029410

(51) Int. Cl. H01M 8/02; H01M 8/04

(52) U.S. Cl. 429/19; 429/27; 429/44

(57) ABSTRACT

The electrode for a fuel cell includes an electrode substrate and a catalyst layer disposed on the electrode substrate. The catalyst layer includes a first catalyst that includes at least one non-noble element-containing compound that includes at least one non-noble element such as cobalt, chromium, molybdenum, iron, and combination thereof and a second catalyst that includes a noble metal.

### CLAIM OF PRIORITY

This application makes reference to, incorporates the same herein, and claims all benefits accruing under 35 U.S.C. §119 from an application for ANODE FOR FUEL CELL AND, MEMBRANE-ELECTRODE ASSEMBLY AND FUEL CELL SYSTEM COMPRISING SAME earlier filed in the Korean Intellectual Property Office on 31 Mar. 2006 and there duly assigned Serial No. 10-2006-0029410.

### BACKGROUND OF THE INVENTION

1. Field of the Invention

The present invention relates to an electrode for a fuel cell, a membrane-electrode assembly and fuel cell system including the same. More particularly, the present invention relates to an electrode for a fuel cell that can lower the cost of a fuel cell and implement a high power fuel cell, and a membrane-electrode assembly and fuel cell system including the same.

2. Description of the Related Art

A fuel cell is a power generation system for producing electrical energy through an electrochemical redox reaction of an oxidant and a fuel such as hydrogen, or a hydrocarbon-based material such as methanol, ethanol, natural gas, and the like. The polymer electrolyte fuel cell is a clean energy source that is capable of replacing fossil fuels. It has advantages such as high power output density and energy conversion efficiency, operability at room temperature, and being small-sized and tightly sealed. Therefore, it can be applicable to a wide array of fields such as non-polluting automobiles, and electricity generation systems and portable power sources for mobile equipment, military equipment, and the like.

Representative exemplary fuel cells include a polymer electrolyte membrane fuel cell (PEMFC) and a direct oxidation fuel cell (DOFC). The direct oxidation fuel cell includes a direct methanol fuel cell that uses methanol as a fuel.

The polymer electrolyte fuel cell has an advantage of having a high energy density while being able to output a high amount of power, but it also has problems because there is a need to carefully handle hydrogen gas and the requirement for accessory facilities such as a fuel reforming processor for reforming methane or methanol, natural gas, and the like in order to produce hydrogen as the fuel gas. On the contrary, a direct oxidation fuel cell has a lower energy density than that of the polymer electrolyte fuel cell, but has the advantages of easy handling of the liquid-type fuel, a low operation temperature, and no need for additional fuel reforming processors.

In the above-mentioned fuel cell system, a stack that generates electricity substantially includes several to scores of unit cells stacked adjacent to one another, and each unit cell is formed of a membrane-electrode assembly (MEA) and a separator (also referred to as a bipolar plate). The membrane-electrode assembly is composed of an anode (also referred to as a “fuel electrode” or an “oxidation electrode”) and a cathode (also referred to as an “air electrode” or a “reduction electrode”) that are separated by a polymer electrolyte membrane.

A fuel is supplied to the anode and adsorbed on catalysts of the anode, and the fuel is oxidized to produce protons and electrons. The electrons are transferred into the cathode via an external circuit, and the protons are transferred into the cathode through the polymer electrolyte membrane. In addition, an oxidant is supplied to the cathode, and then the oxidant, protons, and electrons react on catalysts of the cathode to produce electricity along with water.

In general, a noble metal such as Pt or Ru has been used for a catalyst for an electrode of a fuel cell. However, this catalyst has high cost and also may form an agglomerate during sintering, which may deteriorate catalyst activity. What is needed is an improved design for an electrode for a fuel cell, and a membrane-electrode assembly and a fuel cell system including the same.

### SUMMARY OF THE INVENTION

It is therefore an object of the present invention to provide an electrode that can lower the cost of a fuel cell and that has improved catalyst efficiency.

It is also an object of the present invention to provide a membrane-electrode assembly that includes the electrode.

It is still an object of the present invention to provide a fuel cell system that includes the membrane-electrode assembly.

According to the present invention, a non-noble element-containing compound is included along with a noble-metal-based catalyst in an electrode catalyst layer. The electrode for a fuel cell includes an electrode substrate and a catalyst layer disposed on the electrode substrate. The catalyst layer includes a first catalyst that includes at least one non-noble element-containing compound including at least one non-noble element selected from the group consisting of cobalt, chromium, molybdenum, iron, and combination thereof; and a second catalyst including a noble metal.

According to one embodiment of the present invention, an electrode for a fuel cell includes a first catalyst that includes at least one non-noble element-containing compound that includes at least one non-noble element selected from the group consisting of cobalt, chromium, molybdenum, iron, and combinations thereof and a second catalyst that includes a noble metal. The electrode can be adapted to be an anode in a fuel cell

The non-noble element can be cobalt, molybdenum or a combination thereof. The non-noble element-containing compound can be carbide, a sulfide, a phosphide, a nitride or combinations thereof. The non-noble element-containing compound can include a phosphide. The first catalyst can be cobalt phosphide, molybdenum phosphide or combinations thereof. The noble metal of the second catalyst can be Pt, Ru, Pd, Au, Rh, Ag, Ir, Os, Re or combinations thereof. The first catalyst and second catalyst can be in a state of a physical mixture. The first catalyst and second catalyst can be mixed together at a weight ratio of 99 to 50:1 to 50. The second catalyst can be supported on the first catalyst. 0.01 to 50 parts by weight of the second catalyst can be supported on the 99.99 to 50 parts by weight of the first catalyst.

According to another aspect of the present invention, there is provided a membrane-electrode assembly that includes a anode and a cathode facing each other and an electrolyte arranged between the anode and the cathode, wherein at least one of the anode and cathode includes an electrode substrate and a catalyst layer arranged on the electrode substrate, wherein the catalyst layer includes a first catalyst that includes at least one non-noble element-containing compound including at least one non-noble element selected from the group consisting of cobalt, chromium, molybdenum, iron, and combinations thereof and a second catalyst that includes a noble metal.

The non-noble element can be cobalt, molybdenum or a combination thereof. The non-noble element-containing compound can be a carbide, a sulfide, a phosphide, a nitride or combinations thereof. The noble metal in the second catalyst can be Pt, Ru, Pd, Au, Rh, Ag, Ir, Os, Re or combinations thereof. The first catalyst and second catalyst can be in a state of a physical mixture. The first catalyst and second catalyst can be mixed together at a weight ratio of 99 to 50:1 to 50. The second catalyst can be supported on the first catalyst. 0.01 to 50 parts by weight of the second catalyst can be supported on the 99.99 to 50 parts by weight of the first catalyst.

According to yet another aspect of the present invention, there is provided a fuel cell system that includes at least one electricity generating element a fuel supplier adapted to supply a fuel to each of the at least one electricity element and an oxidant supplier adapted to supply an oxidant to each of the at least one electricity generating element, wherein each of the at least one electricity generating element includes a membrane-electrode assembly and separators arranged on each side of the membrane-electrode assembly, wherein the membrane-electrode assembly comprises a cathode, an anode, and a polymer electrolyte membrane arranged between the cathode and anode, wherein at least one of the anode and cathode includes an electrode substrate; and a catalyst layer arranged on the electrode substrate, wherein the catalyst layer includes a first catalyst that includes at least one non-noble element-containing compound including at least one non-noble element selected from the group consisting of cobalt, chromium, molybdenum, iron, and combinations thereof and a second catalyst that includes a noble metal.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic cross-sectional view showing a membrane-electrode assembly according to one embodiment of the present invention; and

FIG. 2 schematically view of a structure of a fuel cell system according to one embodiment of the present invention.

### DETAILED DESCRIPTION OF THE INVENTION

The present invention relates to an electrode for a fuel cell. In general, a noble metal such as Pt or Ru has been used for a catalyst for an electrode of a fuel cell. However, this catalyst has high cost and also may form an agglomerate during sintering, which may deteriorate catalyst activity. According to one embodiment, a non-noble element-containing compound is included along with a noble-metal-based catalyst in an electrode catalyst layer. The electrode for a fuel cell includes an electrode substrate and a catalyst layer disposed on the electrode substrate. The catalyst layer includes a first catalyst that includes at least one non-noble element-containing compound including at least one of cobalt, chromium, molybdenum, iron, and combination thereof, and a second catalyst including a noble metal.

The non-noble element may be one of cobalt, molybdenum and combination thereof. The non-noble element-containing compound may be carbide, sulfide, phosphide, nitride, and combinations thereof. According to one embodiment, phosphide may be appropriate. The first catalyst may be one of cobalt phosphide, molybdenum phosphide, and combinations thereof.

Non-limiting examples of the first catalyst include one of CoC, CO₂C, CoS, CO₂S, CoP, CO₂P, CoN, CO₂N, CrN, Cr₂N, CrC, Cr₂C, CrS, Cr₂S, CrP, Cr₂P, MoS, Mo₂S, MoP, Mo₂P, MoC, Mo₂C, FeP, Fe₂P, Fe₃P, FeC, Fe₂C, FeN, Fe₂N, FeS, Fe₂S, and combinations thereof. The second catalyst including the noble metal may be one of Pt, Ru, Pd, Au, Rh, Ag, Ir, Os, Re, and combinations thereof. According to one embodiment, Pt may be appropriate.

The first and second catalysts may be used in the form of a catalytic metal itself (black catalyst), or can be used while being supported on a carrier. When the catalyst is used in the form of a catalytic metal itself, that is, a black catalyst not supported on a carrier, first and second catalysts can be simply mixed. According to the embodiment of the present invention, the first and second catalysts can be mixed at a ratio of 99 to 50:1 to 50 wt %. According to another embodiment of the present invention, first and second catalysts can be mixed at a ratio of 90 to 60:10 to 40 wt %. When a second catalyst is used in an amount of less than 1 wt %, the second catalyst may have little effect. On the contrary, when in an amount of the second catalyst is more than 50 wt %, the excess amount of the second catalyst may lead to agglomeration.

Alternatively, when a catalyst is used in the form of a catalytic metal by itself, that is, a black catalyst not supported on a carrier, a second catalyst can be supported on a first catalyst. In other words, the first catalyst can play a role of a carrier for another catalyst. 0.01 to 50 parts by weight of the second catalyst is supported on 99.99 to 50 parts by weight of the first catalyst. According to another embodiment, 1 to 40 parts by weight of the second catalyst is supported on 99 to 60 parts by weight of the first catalyst. When a second catalyst is used in an amount of less than 0.01 wt %, the second catalyst may have too little effect. On the contrary, when in an amount of more than 50 parts by weight, the second catalyst may cover a first catalyst and thereby, increase the size of catalyst particles, resultantly deteriorating catalyst activity.

In addition, the first and second catalysts can be respectively supported on first and second carriers or on one carrier at the same time. Regardless of their supported type, the supported one can improve conductivity by reducing catalyst resistance. The carrier may include a carbon such as activated carbon, denka black, ketjen black, acetylene black, or graphite, or an inorganic particulate such as alumina, silica, zirconia, or titania.

In one embodiment, the electrode substrates are made out of a material such as carbon paper, carbon cloth, carbon felt, or a metal cloth (a porous film composed of metal fiber or a metal film disposed on a surface of a cloth composed of polymer fibers), however the electrode substrate is not limited thereto. The electrode substrates provide a path for transferring reactants such as fuel such as hydrocarbon fuel, carboxylic acid, and an oxidant to the catalyst layers.

The electrode substrates may be treated with a fluorine-based resin to be water-repellent to prevent deterioration of diffusion efficiency due to water generated during the operation of the fuel cell. The fluorine-based resin may include, but is not limited to, polyvinylidene fluoride, polytetrafluoroethylene, fluorinated ethylene propylene, polychlorotrifluoroethylene, a fluoroethylene polymer, or a copolymer thereof.

A microporous layer can be added between the aforementioned electrode substrates and catalyst layer to increase the reactant diffusion effect. The microporous layer generally includes conductive powders with a particular particle diameter. The conductive material may include, but is not limited to, carbon powder, carbon black, acetylene black, activated carbon, carbon fiber, fullerene, nano-carbon, or combinations thereof. The nano-carbon may include a material such as carbon nanotubes, carbon nanofiber, carbon nanowire, carbon nanohoms, carbon nanorings, or combinations thereof.

The microporous layer is formed by coating a composition, including a conductive powder, a binder resin, and a solvent on the conductive substrate. The binder resin may include, but is not limited to, polytetrafluoro ethylene, polyvinylidene fluoride, polyhexafluoro propylene, polyperfluoroalkylvinyl ether, polyperfluoro sulfonylfluoride alkoxy vinyl ether, polyvinyl alcohol, cellulose acetate, or copolymers thereof. The solvent may include, but is not limited to, an alcohol such as ethanol, isopropyl alcohol, n-propyl alcohol, butanol and so on, water, dimethyl acetamide, dimethyl sulfoxide, N-methylpyrrolidone, and tetrahydrofuran. The coating method may include, but is not limited to, screen printing, spray coating, doctor blade methods, gravure coating, dip coating, silk screening, painting, and so on, depending on the viscosity of the composition.

The catalyst layers may include a binder resin to improve its adherence and proton transfer properties. The binder resin may be proton conductive polymer resins having a cation exchange group such as a sulfonic acid group, a carboxylic acid group, a phosphoric acid group, a phosphonic acid group, and derivatives thereof at its side chain. Non-limiting examples of the polymer include at least one proton conductive polymers such as perfluoro-based polymers, benzimidazole-based polymers, polyimide-based polymers, polyetherimide-based polymers, polyphenylenesulfide-based polymers polysulfone-based polymers, polyethersulfone-based polymers, polyetherketone-based polymers, polyether-etherketone-based polymers, and polyphenylquinoxaline-based polymers. In one embodiment, the proton conductive polymer is at least one selected from the group consisting of poly(perfluorosulfonic acid), poly(perfluorocarboxylic acid), a copolymer of tetrafluoroethylene and fluorovinylether having a sulfonic acid group, defluorinated polyetherketone sulfide, aryl ketone, poly(2,2′-(m-phenylene)-5,5′-bibenzimidazole), or poly(2,5-benzimidazole).

The binder resins may be used singularly or in combination. They may be used along with non-conductive polymers to improve adherence with a polymer electrolyte membrane. The binder resins may be used in a controlled amount corresponding to their purposes. Non-limiting examples of the non-conductive polymers include polytetrafluoroethylene (PTFE), tetrafluoroethylene-hexafluoropropylene copolymers (FEP), tetrafluoroethylene-perfluoro alkyl vinylether copolymers (PFA), ethylene/tetrafluoroethylene (ETFE), chlorotrifluoroethylene-ethylene copolymers (ECTFE), polyvinylidenefluoride, polyvinylidenefluoride-hexafluoropropylene copolymers (PVdF-HFP), dodecylbenzenesulfonic acid, sorbitol, or combinations thereof.

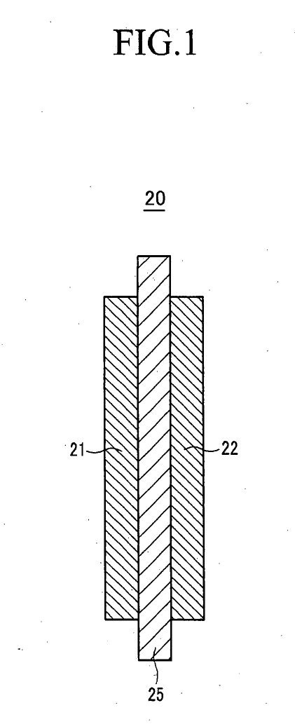

According to another embodiment of the present invention, a membrane-electrode assembly includes the anode and cathode having a structure as above, and a polymer electrolyte membrane interposed between the cathode and anode. The membrane-electrode assembly 20 is schematically shown in FIG. 1. Referring to FIG. 1, the membrane-electrode assembly 20 includes a polymer electrolyte membrane 25, and a cathode 21 and an anode 22 disposed at each side of the polymer electrolyte membrane 25.

Either or both of the cathode 21 and anode 22 may be composed of the above described electrode. In case that either of the cathode 21 and anode 22 is the above electrode, the other electrode may include any catalyst that can perform a fuel cell reaction. The catalyst includes platinum-based catalysts. The platinum-based catalyst includes platinum, ruthenium, osmium, a platinum-ruthenium alloy, a platinum-osmium alloy, a platinum-palladium alloy, a platinum-M alloy, or combinations thereof, where M is transition element such as Ga, Ti, V, Cr, Mn, Fe, Co, Ni, Cu, Zn, Sn, Mo, W, Rh, Ru, and combinations thereof. Representative examples of the catalysts include are Pt, Pt/Ru, Pt/W, Pt/Ni, Pt/Sn, Pt/Mo, Pt/Pd, Pt/Fe, Pt/Cr, Pt/Co, Pt/Ru/W, Pt/Ru/Mo, Pt/Ru/V, Pt/Fe/Co, Pt/Ru/Rh/Ni, Pt/Ru/Sn/W, and combinations thereof.

The polymer electrolyte membrane functions as an ion-exchange member to transfer protons generated in an anode catalyst layer to the cathode catalyst layer. The polymer electrolyte membrane of the membrane-electrode assembly may generally include a proton conductive polymer resin. The proton conductive polymer resin may be a polymer resin having a cation exchange group such as a sulfonic acid group, a carboxylic acid group, a phosphoric acid group, a phosphoric acid group, and derivatives thereof, at its side chain.

Non-limiting examples of the polymer resin are fluoro-based polymers, benzimidazole-based polymers, polyimide-based polymers, polyetherimide-based polymers, polyphenylenesulfide-based polymers polysulfone-based polymers, polyethersulfone-based polymers, polyetherketone-based polymers, polyether-etherketone-based polymers, and polyphenylquinoxaline-based polymers. In a preferred embodiment, the proton conductive polymer is one of poly(perfluorosulfonic acid) (NAFION™), poly(perfluorocarboxylic acid), a copolymer of tetrafluoroethylene and fluorovinylether having a sulfonic acid group, defluorinated polyetherketone sulfide, aryl ketone, poly(2,2′-(m-phenylene)-5,5′-bibenzimidazole), and poly(2,5-benzimidazole).

The hydrogen (H) in the proton conductive group of the proton conductive polymer can be substituted with Na, K, Li, Cs, or tetrabutylammonium. When the H in the ionic exchange group of the terminal end of the proton conductive polymer side is substituted with Na or tetrabutylammonium, NaOH or tetrabutylammonium hydroxide may be used, respectively. When the H is substituted with K, Li, or Cs, appropriate compounds for the substitutions may be used. Since such a substitution is known to this art, a detailed description thereof is omitted.

A fuel cell system including the membrane-electrode assembly of the present invention includes at least one electricity generating element, a fuel supplier, and an oxidant supplier. The electricity generating element includes a membrane-electrode assembly and a separator. It generates electricity through oxidation of a fuel and reduction of an oxidant. The fuel supplier plays a role of supplying the electricity generating element with a fuel. The fuel includes liquid or gaseous hydrogen, or a hydrocarbon-based fuel such as methanol, ethanol, propanol, butanol, or natural gas.

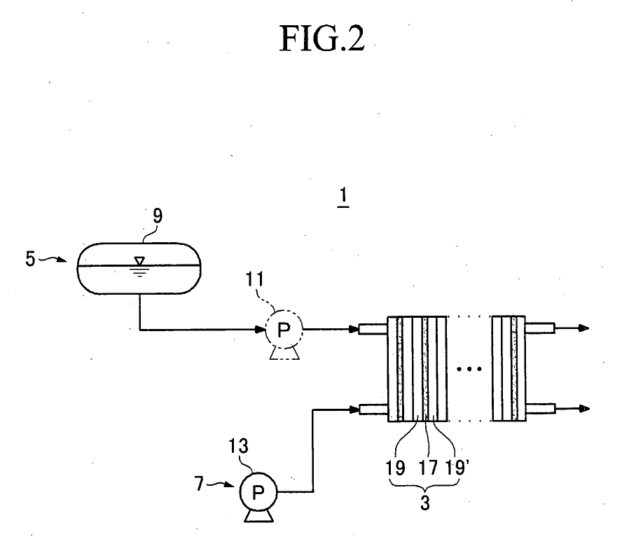

FIG. 2 shows a schematic view of a fuel cell system 1 wherein a fuel and an oxidant are provided to the electricity generating element through pumps, but the present invention is not limited to such a structure. The fuel cell system 1 of the present invention alternatively includes a structure wherein a fuel and an oxidant are provided in a diffusion manner.

A fuel cell system 1 includes at least one electricity generating element 3 that generates electrical energy through an electrochemical reaction of a fuel and an oxidant, a fuel supplier 5 for supplying a fuel to the electricity generating element 3, and an oxidant supplier 7 for supplying an oxidant to the electricity generating element 3. In addition, the fuel supplier 5 is equipped with a tank 9 that stores fuel, and a pump 11 that is connected therewith. The fuel pump 11 supplies fuel stored in the tank 9 with a predetermined pumping power.

The oxidant supplier 7, which supplies the electricity generating element 3 with an oxidant, is equipped with at least one pump 13 for supplying an oxidant with a predetermined pumping power. The electricity generating element 3 includes a membrane-electrode assembly 17 that oxidizes hydrogen or the fuel and reduces the oxidant, and separators 19 and 19′ that are respectively positioned at opposite sides of the membrane-electrode assembly 17 and supply hydrogen or the fuel, and the oxidant, respectively.

The following examples illustrate the present invention in more detail. However, it is understood that the present invention is not limited to these examples.

### EXAMPLE 1

CoP as a first catalyst, Pt—Ru black (Johnson Matthey Co.) as a second catalyst, and NAFION/H₂O/2-propanol (Solution Technology Inc.) in a 5 wt % concentration as a binder were mixed at a weight ratio of 44 wt %:44 wt %:56 wt % to prepare a catalyst composition for an electrode. Next, the catalyst composition for an electrode was coated on a carbon paper including 0.2 mg/cm² of carbon to prepare an anode respectively loaded with first and second catalysts in 2 mg/cm² (in total 4 mg/cm²).

88 wt % of Pt black (Johnson Matthey Co.) catalyst and 12 wt % of NAFION/H₂O/2-propanol (Solution Technology Inc.) in a 5 wt % concentration as a binder were mixed to prepare a composition for a cathode. The composition for a cathode was coated on a carbon paper including 1.3 mg/cm² of carbon to prepare a cathode loaded with a catalyst in a 4 mg/cm².

The prepared anode and cathode and a commercially-available NAFION 115 (perfluorosulfonate) polymer electrolyte membrane were used to prepare a unit cell.

### EXAMPLE 2

A unit cell is fabricated according to the same method as in Example 1, except that CoS was used instead of CoP for the first catalyst.

### EXAMPLE 3

A unit cell is fabricated according to the same method as in Example 1, except that CoC was used instead of CoP for the first catalyst.

### EXAMPLE 4

A unit cell is fabricated according to the same method as in Example 1, except that CoN was used instead of CoP for the first catalyst.

### EXAMPLE 5

A unit cell is fabricated according to the same method as in Example 1, except that MoC was used instead of CoP for the first catalyst.

### EXAMPLE 6

A unit cell is fabricated according to the same method as in Example 1, except that MoS was used instead of CoP for the first catalyst.

### EXAMPLE 7

A unit cell is fabricated according to the same method as in Example 1, except that MoP was used instead of CoP for the first catalyst.

### EXAMPLE 8

A unit cell is fabricated according to the same method as in Example 1, except that FeC was used instead of CoP for the first catalyst.

### EXAMPLE 9

A unit cell is fabricated according to the same method as in Example 1, except that FeS was used instead of CoP for the first catalyst.

### EXAMPLE 10

A unit cell is fabricated according to the same method as in Example 1, except that FeP was used instead of CoP for the first catalyst.

### EXAMPLE 11

A unit cell is fabricated according to the same method as in Example 1, except that FeN was used instead of CoP for the first catalyst.

### COMPARATIVE EXAMPLE 1

A unit cell is fabricated according to the same method as in Example 1, except that the first catalyst was not used and Pr—Ru black catalyst (Johnson Matthey Co.) was used in an amount of 88 wt %.

Each unit cell fabricated according to Examples 1, 3, and 7 and Comparative Example 1 was measured regarding its power density at 0.4V and 70° C., and the result was provided in the following Table 1.

TABLE 1

| | | | | Comparative |
|---|---|---|---|---|
| | Example 1 | Example 3 | Example 7 | Example 1 |
| Power density | 100 | 70 | 100 | 100 |
| (mW/cm²) | | | | |

As shown in Table 1, the unit cells of Examples 1 and 7 that include cobalt phosphide and molybdenum phosphide turned out to have the most superior power density. In addition, even though they included one-half the Pt—Ru black catalyst as that of Comparative Example 1, they had the same power density. Accordingly, the Pt—Ru black catalyst can be replaced with cobalt phosphide or molybdenum phosphide, which is less expensive than the Pt—Ru black catalyst. Furthermore, the present invention can prevent activity deterioration due to sintering of a Pt—Ru catalyst and thereby, improve catalyst performance.

Therefore, an electrode according to the present invention includes a non-noble element-containing compound such as cobalt, chromium, molybdenum, or iron compound as a main catalyst and also, a little quantity of a noble-metal-based catalyst, and thus provide a less expensive electrode while maintaining superior electrical performance.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An electrode, comprising:
a first catalyst that includes at least one non-noble element-containing compound that includes at least one non-noble element selected from the group consisting of cobalt, chromium, molybdenum, iron, and combinations thereof; and
a second catalyst that includes a noble metal.

2. The electrode of claim 1, wherein the non-noble element is selected from the group consisting of cobalt, molybdenum, and a combination thereof.

3. The electrode of claim 1, wherein the non-noble element-containing compound being a material selected from the group consisting of a carbide, a sulfide, a phosphide, a nitride, and combinations thereof.

4. The electrode of claim 1, wherein the non-noble element-containing compound comprises a phosphide.

5. The electrode of claim 1, wherein the first catalyst comprises a material selected from the group consisting of cobalt phosphide, molybdenum phosphide, and combinations thereof.

6. The electrode of claim 1, wherein the noble metal of the second catalyst comprises a material selected from the group consisting of Pt, Ru, Pd, Au, Rh, Ag, Ir, Os, Re, and combinations thereof.

7. The electrode of claim 1, wherein the first catalyst and second catalyst are in a state of a physical mixture.

8. The electrode of claim 7, wherein the first catalyst and second catalyst are mixed together at a weight ratio of 99 to 50:1 to 50.

9. The electrode of claim 1, wherein the second catalyst is supported on the first catalyst.

10. The electrode of claim 9, wherein 0.01 to 50 parts by weight of the second catalyst is supported on the 99.99 to 50 parts by weight of the first catalyst.

11. The electrode of claim 1, the electrode being adapted to be an anode in a fuel cell.

12. A membrane-electrode assembly, comprising:
a anode and a cathode facing each other; and
an electrolyte arranged between the anode and the cathode,
wherein at least one of the anode and cathode comprises
an electrode substrate; and
a catalyst layer arranged on the electrode substrate,
wherein the catalyst layer comprises
a first catalyst that includes at least one non-noble element-containing compound including at least one non-noble element selected from the group consisting of cobalt, chromium, molybdenum, iron, and combinations thereof; and
a second catalyst that includes a noble metal.

13. The membrane-electrode assembly of claim 12, wherein the non-noble element is selected from the group consisting of cobalt, molybdenum, and a combination thereof.

14. The membrane-electrode assembly of claim 12, wherein the non-noble element-containing compound comprises a material selected from the group consisting of a carbide, a sulfide, a phosphide, a nitride, and combinations thereof.

15. The membrane-electrode assembly of claim 12, wherein the noble metal in the second catalyst comprises a material selected from the group consisting of Pt, Ru, Pd, Au, Rh, Ag, Ir, Os, Re, and combinations thereof.

16. The membrane-electrode assembly of claim 12, wherein the first catalyst and second catalyst are in a state of a physical mixture.

17. The membrane-electrode assembly of claim 16, wherein the first catalyst and second catalyst are mixed together at a weight ratio of 99 to 50:1 to 50.

18. The membrane-electrode assembly of claim 12, wherein the second catalyst is supported on the first catalyst.

19. The membrane-electrode assembly of claim 18, wherein 0.01 to 50 parts by weight of the second catalyst is supported on the 99.99 to 50 parts by weight of the first catalyst.

20. A fuel cell system, comprising:
at least one electricity generating element;
a fuel supplier adapted to supply a fuel to each of the at least one electricity element; and
an oxidant supplier adapted to supply an oxidant to each of the at least one electricity generating element, wherein each of the at least one electricity generating element comprises a membrane-electrode assembly and separators arranged on each side of the membrane-electrode assembly, wherein the membrane-electrode assembly comprises a cathode, an anode, and a polymer electrolyte membrane arranged between the cathode and anode, wherein at least one of the anode and cathode comprises
an electrode substrate; and
a catalyst layer arranged on the electrode substrate, wherein the catalyst layer comprises
a first catalyst that includes at least one non-noble element-containing compound including at least one non-noble element selected from the group consisting of cobalt, chromium, molybdenum, iron, and combinations thereof; and
a second catalyst that includes a noble metal.
